(19) United States
(12) Patent Application Publication
(10) Pub. No.: US 2024/0416608 A1
(43) Pub. Date: Dec. 19, 2024

(54) METHOD AND DEVICE FOR PRESSING

(71) Applicant: Harburg-Freudenberger Maschinenbau GmbH, Hamburg (DE)

(72) Inventor: Moritz VÖLTZER, Hamburg (DE)

(21) Appl. No.: 18/698,501

(22) PCT Filed: Aug. 9, 2022
(86) PCT No.: PCT/DE2022/100579

§ 371 Date: Apr. 5, 2024

(30) Foreign Application Priority Data
Oct. 5, 2021 (DE) 10 2021 125 760.3

(51) Int. Cl. B30B 9/14; B01D 29/11; C11B 1/08

(52) U.S. Cl. CPC B30B 9/14; B01D 29/11; C11B 1/08

(57) ABSTRACT

A method and a device for pressing, wherein an extraction agent is fed into the pressing chamber in addition to the mechanical pressing process. The extraction agent serves to extract oil from the press cake and simultaneously to cool the press cake and the pressed oil, so that a high product quality of press cake and oil and simultaneously a good oil yield can be realized.

The invention relates to a device for pressing, in particular in the sense of a screw press.

The invention also relates to a method of pressing.

Such methods and devices are used to press liquids out of a press cake, for example oil from oily seeds. For this purpose, the pressed material is fed to a pressing device, for example in the form of a screw press, in which liquid is removed from the press cake by mechanical pressing, so that solid and liquid components of the pressed material are separated from each other.

Furthermore, corresponding processes and devices are also used in rendering to press fat out of animal carcasses.

Screw presses have a worm shaft that is rotatably mounted in a pressing chamber. The pressing chamber is bounded by a so-called strainer basket in a tubular shape, whereby the pressed material is fed in at a first end and the press cake is ejected at the second end. The strainer basket has circumferential openings, which are usually designed as slots running parallel to the axis of rotation of the worm shaft and through which the pressed liquid can escape from the pressing chamber. These slots are usually formed by the spaces between the strainer bars arranged next to each other.

During the pressing process, the mechanical friction and high pressures can result in very high temperatures, which affect both the quality of the press cake and the pressed liquid as well as the operational safety of the press.

Limiting the temperature during the pressing process has a positive effect on both the press cake itself and the liquid to be pressed in terms of product quality.

After pressing, the press cake is used, for example, as animal feed or as a dietary supplement, so that certain quality requirements have to be met.

For example, one requirement in this regard is to achieve the highest possible PDI value (Protein Dispersibility Index) in the press cake. This value stands for the solubility of the proteins in the press cake, which is negatively influenced by the protein denaturation that occurs at high temperatures.

With regard to the quality of pressed liquids, the aim is to obtain the highest possible allyl isothiocyanate (AITC) content in mustard oil pressed from mustard seeds, for example, as the AITC content causes the pungent taste.

The AITC content also decreases with increasing temperatures during the pressing process.

Keeping the temperature as low as possible during the pressing process is therefore of considerable importance for both of the aforementioned objectives with regard to the product quality of the press cake and pressed liquid.

However, particularly with regard to oils as pressed liquids, cooling the press cake during the pressing process has a detrimental effect on the viscosity, making it more difficult for it to drain.

DE 10 2007 014 775 A1 proposes methods and devices of the aforementioned type which enable an improvement in the product quality of the oil obtained, in particular for use in edible oil production, which is achieved in particular by limiting the temperature of the extract to a maximum of 60° C. during the entire extraction process by using supercritical CO2 as the extraction agent.

The addition of supercritical CO2 during the pressing process thus acts both as a coolant and as an extraction agent in the true sense of the word. When this principle is applied to the extraction of seed oil, the dissolution of the carbon dioxide in the oil results in a considerable reduction in viscosity and thus a significant liquefaction, so that the detrimental effect of cooling on the viscosity of the oil is at least compensated for.

However, the disadvantages of using CO2 as a cooling medium for screw presses are the comparatively high costs of liquid CO2, the complex design of the pressing device itself required for this and safety aspects. The use of CO2 requires an elaborate sealing of the press with a closed chamber and the use of gas warning devices by personnel working in the area of the press in order to prevent and/or detect an asphyxiating atmosphere in the area of the press. The closed chamber also prevents the pressed liquid from draining in this area, meaning that the entire length of the press chamber cannot be fully utilised.

It is therefore an object of the invention to provide a device for pressing with which the pressed material and/or the pressed liquid can be cooled during pressing, whereby the disadvantages occurring when using supercritical CO2 do not occur at least in part.

According to the invention, this object is achieved by a device for pressing according to patent claim 1.

It is a further object of the invention to provide a method for pressing with which the pressed material and/or the pressed liquid can be cooled during pressing, whereby the disadvantages occurring when using supercritical CO2 do not occur at least in part.

According to the invention, this object is achieved by a method for pressing according to patent claim 16.

The features of a device for pressing and a method for pressing disclosed in the following are part of the invention both individually and in all practicable combinations.

According to the concept of the invention, an extraction agent is introduced into the pressing chamber of a pressing device, which is selected so that it remains liquid for as long as possible at the temperatures and pressures prevailing inside the pressing chamber and gaseous at ambient pressure at a target temperature. As a result, the extraction agent vaporizes abruptly when it leaves the pressing chamber and the extracted oil can be conveyed in liquid form out of a trough arranged at the bottom of the press.

The teaching according to the invention thus combines the mechanical pressing and extraction of oil with the aid of an extraction agent to reduce the residual fat content in the press cake and improve the oil yield while simultaneously utilizing a cooling effect of the extraction agent to improve the quality of the oil and/or the press cake.

A pressing device according to the invention is designed as a mechanical pressing device, in particular as a screw press, and has means for feeding an extraction agent into the pressing chamber.

The means for supplying an extraction agent comprise at least one extraction agent source and at least one extraction agent outlet, which is arranged on the device for pressing in such a way that the extraction agent can be introduced into the pressing chamber.

In embodiments of the invention, the extraction agent source can be designed, for example, as an extraction agent container or reservoir in which extraction agent is stored under pressure, or as a device for recovering the extraction agent. In embodiments of the invention, the extraction agent is stored under ambient pressure. Particularly preferably, the extraction agent is stored in liquid form and the extraction agent container is designed accordingly.

Particularly preferably, the pressing device has a plurality of extracting agent outlets.

In embodiments of the invention, the at least one extraction agent source and the at least one extraction agent outlet are connected to each other via at least one extraction agent line.

Preferably, at least one extraction agent valve and/or an extraction agent pump is provided, via which the supply of extraction agent into the pressing chamber of the device for pressing can be controlled.

In advantageous embodiments of the invention, the temperature of the extraction agent can be adjusted, for example with the aid of a heat exchanger, prior to injection into the pressing chamber.

In particularly advantageous embodiments of the invention, the mass fraction of the extracting agent in the strainer basket can be adjusted with the aid of the at least one extracting agent valve and/or the at least one extracting agent pump.

In preferred embodiments of the invention, the at least one extraction agent outlet is arranged close to the worm shaft or in the worm shaft itself, so that the extraction agent is injected close to the worm shaft. This maximizes the path that the extracting agent has to take through the press cake before leaving the press chamber, so that the dissolving effect of the extracting agent is maximized.

In embodiments of the invention, at least one extraction agent outlet is arranged on the worm shaft.

In one embodiment of the invention, the extracting agent is injected from the inside of the worm shaft through an extracting agent outlet.

In other embodiments of the invention, the extracting agent is injected through extracting agent outlets projecting into the pressing chamber from the outside. This arrangement of the extracting agent outlets makes it easier to retrofit conventional devices for pressing compared to injection from the worm shaft.

In embodiments of the invention, the injection of the extracting agent from the inside of the worm shaft through an extracting agent outlet and the injection of the extracting agent through extracting agent outlets projecting into the press chamber from the outside are combined.

When the extraction agent is injected through extraction agent outlets projecting into the press chamber from the outside, in embodiments of the invention these are arranged behind throttle rings in areas in the conveying direction of the press. In these relaxation and mixing zones, the introduced extraction agent can optimally come into contact with the press cake.

According to the invention, the extraction agent is designed as a fat dissolver to dissolve oils from the press cake.

The extraction agent is advantageously at least partially non-polar, preferably completely non-polar.

For optimum usability of the extraction agent, it is preferably selected so that it is liquid at the temperatures and pressures prevailing in the pressing chamber during operation and is gaseous at the atmospheric pressure or ambient pressure of about 1.013 bar a (absolute pressure) prevailing outside the pressing chamber, so that the extraction agent vaporizes as completely as possible during or shortly after leaving the strainer basket. However, embodiments are also possible in which the extraction agent already vaporizes before leaving the strainer basket.

On the one hand, this ensures good extraction of the oil from the press cake and, on the other hand, cooling of the press cake and the oil by vaporizing the extraction agent as it leaves the strainer basket.

Preferably, the extraction agent has a vapor pressure of 1.1-7 bar a at 60° C. This ensures that the extraction agent vaporizes safely due to the pressure drop after leaving the strainer basket and is preferably still liquid at least until shortly before it leaves.

The temperature of 60° C. corresponds to the target temperature of the press cake. Accordingly, the extraction agent has approximately the same temperature when it exits the strainer basket. If a different, in particular a higher, target temperature is selected, the extraction agent may have to be adjusted so that the vapor pressure is correctly selected for the corresponding effect according to the invention. The relevant temperature range for the target temperature of the press cake is between about 50° C. and 140° C., in embodiments of the invention between about 50° C. and 120° C., particularly preferably between 50° C. and 80° C. Most preferably, the target temperature of the press cake is between about 60° C. and 80° C. The lower limit is determined in particular by the desired minimum yield, since the viscosity of the oil increases with lower temperature and this is therefore more difficult to separate from the press cake. The upper limit is determined in particular by qualitative demands on the oil and/or the press cake and the associated maximum temperatures during pressing.

The desired cooling effect is determined in particular by the vaporization of the extraction agent as it leaves the strainer basket and thus by the enthalpy of vaporization of the extraction agent.

The enthalpy of vaporization of the extraction agent at atmospheric pressure is preferably in a range of 280 KJ/kg to 400 KJ/kg, so that a cooling effect can be achieved to the desired extent.

In embodiments of the invention, the extraction agent is selected as n-butane and/or isopentane.

At 60° C. and atmospheric pressure, isopentane has an enthalpy of vaporization of 316 KJ/kg and n-butane of 319 KJ/kg. The vapor pressure of isopentane at 60° C. is 2.8 bar a and of n-butane 6.44 bar a.

Preferably, the extraction agent is toxic to the lowest possible degree, particularly preferably non-toxic.

Another desirable property of the extraction agent is its easy and inexpensive availability.

Based on the aforementioned desired properties of the extraction agent, it is therefore important that the extraction agent remains in a liquid state in the strainer basket for as long as possible. It must therefore be ensured that the pressure in the strainer basket does not drop too much, at least in an area with a certain length in the conveying direction immediately adjacent to the injection of the extraction agent.

For isopentane as an extraction agent, for example, it is necessary at a temperature of 60° C. that the pressure does not fall below 1.7 bar a so that it remains liquid.

In embodiments of the invention, this problem is solved by an at least partially sealed area of the strainer basket in the conveying direction immediately adjacent to the injection of the extraction agent. The fact that in this area no or only small quantities of pressed liquid and extraction agent can escape from the pressing chamber through openings in the strainer basket increases the flow resistance in this area and the pressure in this area is kept high, and the residence time of the extraction agent in the strainer is also increased by the use of a sealed area.

The sealed area can be sealed, for example, by inserting a tube with the corresponding diameter at least in the directly adjacent strainer section in the conveying direction or by completely or partially sealing the openings between the strainer bars at least in the directly adjacent strainer section in the conveying direction.

In embodiments of the invention, the sealed area begins in the conveying direction even before the position of the injection of the extraction agent.

In embodiments of the invention, the device for pressing has a plurality of areas in the longitudinal direction in which the extraction agent is injected, with a sealed area directly adjacent to the injection in the conveying direction.

The injection areas in conjunction with the respective sealed areas are preferably arranged alternately with conventional strainer fields, in the sense that at least one strainer field permeable to the pressed liquid and the extraction agent is arranged between two injection areas.

In an advantageous embodiment of the invention, the device for pressing has a recovery device for the extraction agent that has escaped from the strainer basket. As a result, at least part of the extraction agent introduced can be recovered so that it does not have to be purchased or produced again.

The recovery device can be integrated into an aspiration system of the pressing device so that the gas mixture extracted from the press frame with the aid of the aspiration system can be fed to the recovery device.

Preferably, recovery takes place with the aid of a condensation device of the recovery unit.

For this purpose, the extraction agent is advantageously selected so that it has a condensation temperature of between approximately 10° C. and 40° C. at atmospheric pressure.

The condensation temperature at ambient pressure (1.013 bar a) is −0.5° C. for n-butane and 28° C. for isopentane.

In one embodiment of the invention, the recovery device has a water cooling system. The condensation temperature of the extraction agent is preferably selected to be between about 22° C. and 27° C.

In one embodiment of the invention, the recovery device has a chiller or a cooling device for cooling down the cooling water of the water cooling system. Extraction agents with a condensation temperature down to about 10° C. can then also be used.

In an alternative embodiment of the invention, the recovery device has a compressor for compressing the exhaust air stream containing the extracting agent so that it or the extracting agent it contains condenses at higher temperatures. However, these embodiments are relatively complex and potentially dangerous as they are used in a potentially explosive atmosphere. However, in such embodiments of the invention, it is possible to use n-butane as the extraction agent if a corresponding condensation recovery is desired.

In embodiments of the invention, the pressing device has an aspiration system. With the aid of the aspiration system, the gas mixture can be extracted from the press frame and, if necessary, the surroundings of the press can also be supplied with fresh air, so that, on the one hand, the risk of explosion due to the formation of an explosive air-gas mixture within the press frame and/or a risk of asphyxiation for persons in the immediate vicinity of the press is reduced.

In an advantageous embodiment of the invention, the housing or cladding of the press is used to encapsulate the interior of the press from the environment so that no explosive gas-air mixture can form.

Flap seals can be used for additional safety. Flap seals are seals for flaps that form part of a housing or the casing of a pressing device. These flaps are used to provide accessibility to the strainer basket of a pressing device, for example for maintenance purposes, and at the same time shield the interior of the pressing device from the environment. Sealing the flaps supports this shielding so that the escape of gases from the pressing device into the surrounding work area is prevented. In embodiments of the invention, the flap seals are designed as rubber lips arranged on the edges of the flaps.

In preferred embodiments of the invention, flap seals are combined with aspiration of the press interior.

In preferred embodiments of the invention, the pressing device has a trub shearing device. With the aid of the trub shearing device, which has movable blades on the outside of the strainer basket, trub emerging from the strainer basket can be cut off from it. Particularly at the end of the press, the trub can be very solid and clog the openings of the strainer basket.

As it is not possible to open the casing of the press, for example by opening the side flaps, during operation due to the gases, it is not possible to manually shear off the trub during operation.

In one embodiment of the invention, the device for pressing has an inert gas supply with which an inert gas can be introduced into the interior of the press. This is particularly useful if the vaporizing extraction agent alone cannot form a non-explosive atmosphere. Nitrogen, for example, can be used as the inert gas.

In embodiments of the invention, the inert gas can also be fed into the strainer basket or directly to the strainer basket with the aid of the inert gas feed, so that it can be used as an additional coolant.

In one embodiment of the invention, the pressing device has water-cooled drives that do not require a belt drive. This serves the purpose of explosion protection.

In one embodiment of the invention, the device for pressing has a crusher ring and/or a cake crusher for crushing the press cake in the region of the press cake outlet of the device for pressing. The crushing and opening of the press cake increases the surface area of the press cake and promotes the evaporation of the extraction agent from the press cake, since the latter can still contain about 10% extraction agent when it leaves the separator without a crusher ring.

Alternatively or additionally, the chute over which the press cake is passed after pressing and to which the aspiration system is connected can be made longer, so that the dwell time of the press cake on the chute is extended and a longer time is available for the evaporation of the extraction agent from the press cake.

At ambient pressure, the extraction agent content in the press cake can be significantly reduced, as the remaining 10% extraction agent cools the press cake via flash evaporation from 60° C. to approx. 30° C., which is just above the boiling temperature of the extraction agent (e.g. isopentane) at ambient pressure.

Alternatively or additionally, it is also conceivable to place the press cake in a vacuum chamber in order to remove any remaining extraction agent from it. This also makes it possible to prevent any remaining extraction agent from escaping into the surrounding atmosphere.

Due to the vapor pressure of the extraction agent, which is below the ambient pressure, any residues remaining in the press cake degas even at ambient pressure and temperature.

In embodiments of the invention, the trub oil is passed through an oil drier to remove any remaining extractant from it. This also makes it possible to prevent any remaining extractant from escaping into the surrounding atmosphere.

For applications in particular in rendering, the device according to the invention has, in corresponding embodiments, a post-treatment device for the trub fat, which comprises a separating device for further separation of solids from the trub fat. This separating device can, for example, be designed as a (vibrating) sieve or as a sedimentation device.

A method of pressing according to the invention comprises at least the following method steps:
Providing an extraction agent using an extraction agent source
Feeding the extraction agent from the extraction agent source into the pressing chamber of a screw press
Cooling the press cake and/or the pressed liquid using the extraction agent and dissolving the oil contained in the press cake

A pressed product or press cake is fed into a screw press through a feed opening and transported through a pressing chamber by means of a worm shaft and pressed so that a liquid is squeezed out of the press cake. The pressed liquid, in particular oil, exits the press chamber through openings.

The extraction agent is fed to the screw press in a liquid state, as this is colder and has a greater cooling effect, allowing the oil to be better released from the press cake.

Preferably, the extraction agent is injected into the pressing chamber in the area of the worm shaft or close to the worm shaft so that the extraction agent comes into good contact with the press cake on its way out of the pressing chamber. The extraction effect increases with increasing contact and increasing mixing of the extraction agent and press cake.

In preferred embodiments of the method for pressing according to the invention, the properties of the extraction agent correspond to the properties explained in connection with the device for pressing.

In embodiments of the invention, the temperature of the press cake in the pressing chamber of the device for pressing is adjusted in a range from 50° C. to 140° C. by feeding the extraction agent.

In preferred embodiments of the invention, the temperature of the press cake in the pressing chamber of the device for pressing is set in a range from 50° C. to 120° C. by feeding the extraction agent.

In particularly preferred embodiments of the invention, the temperature of the press cake in the pressing chamber of the device for pressing is set in a range from 50° C. to 80° C. by feeding the extraction agent.

In particularly preferred embodiments of the invention, the temperature of the press cake in the pressing chamber of the device for pressing is set in a range of approximately 60° C. to 80° C. by feeding the extraction agent.

In one embodiment of the process according to the invention, the amount of extraction agent supplied is adjusted so that the mass fraction of the extraction agent in the strainer basket is approximately 5 to 35%.

In embodiments of the invention, the mass flow for the press cake can be set to 200 to 1000 t/d seed equivalent for pre-pressing, 90 to 170 t/d seed equivalent for post-pressing and 30 to 100 t/d seed equivalent for final pressing. In other embodiments, however, other, in particular lower mass flows can also be set.

In embodiments of the process according to the invention, the temperature of the press cake and the mass fraction of the extraction agent are adjusted by the corresponding control of at least one extraction agent valve and/or at least one extraction agent pump and/or by adjusting the temperature of the extraction agent during injection into the press chamber.

For example, the extracting agent valve is designed as a control valve and the extracting agent pump is designed as a frequency-controlled pump.

The residual fat content of the press cake can also be adjusted by the quantity and temperature of the extraction agent added.

In embodiments of the invention, the temperature of the extracting agent supplied is less than 70° C., preferably less than 50° C., particularly preferably less than 30° C.

The temperature of the extracting agent supplied can be adjusted using a heat exchanger, for example. For example, cooling water can be used in the heat exchanger as a cooling medium or steam can be used to heat the extraction agent.

In an advantageous embodiment of the invention, the extraction agent discharged from the strainer basket is at least partially recovered with the aid of a recovery device, so that it does not have to be purchased or produced anew.

Preferably, recovery takes place with the aid of a condensation device of the recovery unit.

In one embodiment of the process according to the invention, recovery is realized by condensation of the extractant with the aid of cooling the extractant to a temperature equal to or below the condensation temperature of the extractant.

According to the invention, this can be realized with the aid of cooling water.

However, it should be noted that this condensation temperature is the temperature at which the pressing aid condenses at the partial pressure of the pressing aid. This means that if inert gas is used, which is absolutely necessary during start-up, for example, the condensation temperature drops accordingly.

In one embodiment of the invention, the cooling water is cooled using a chiller or cooling device. Extraction agents with a condensation temperature down to about 10° C. can then also be used.

In an alternative embodiment of the invention, the extraction agent for recovery is compressed using a compressor so that it condenses at higher temperatures and no or only minimal cooling is required.

In embodiments of the invention, the gas mixture is extracted from the press frame by means of an aspiration system and, if necessary, the surroundings of the press are additionally supplied with fresh air, so that, on the one hand, the risk of explosion due to the formation of an explosive air-gas mixture within the press frame and/or a risk of asphyxiation for persons in the immediate vicinity of the press is reduced.

In preferred embodiments of the invention, at least a portion of the trub exiting the strainer basket is sheared off using a trub shearing device.

In one embodiment of the invention, an inert gas is introduced into the interior of the press.

In one embodiment of the invention, the press cake is opened or crushed in the area of the press cake outlet of the pressing device using a crusher ring and/or a cake crusher.

The extraction agent remaining in the press cake evaporates after the press cake leaves the strainer basket.

In alternative embodiments of the invention, the press cake is post-treated under negative pressure after leaving the strainer basket.

The press cake remains under negative pressure for a certain period of time if this appears necessary due to target values for the press cake and/or any remaining pressing agent should not escape into the surrounding atmosphere.

In embodiments, the press cake is heated to a temperature of about 60° C., since the temperature of the press cake drops to about 30° C. due to the preceding flash evaporation and the extraction agent remaining in the press cake can be removed more easily at about 60° C. without significantly worsening the PDI value of the cake.

This heating can be carried out with direct steam if necessary, so that stripping is already carried out here.

At a pressure of 70 mbar a, which can be realized relatively easily with a water ring pump, the press cake degasses to an extractant content of approx. 1000 ppm (isopentane).

For the desired limit value of max. 300 ppm isopentane in the press cake, a calculated pressure of approx. 20 mbar a is required. This pressure can be achieved with gas ejectors or dry vacuum pumps, for example.

The above values are based on rapeseed press cake, as the extraction agent is particularly difficult to remove from this compared to sunflower seed press cake and soya press cake.

In order to achieve the usually required limit value of 300 ppm (0.03%), it may be necessary to subject the press cake to a stripping process. When stripping press cake, water vapor is usually passed through the cake, which largely entrains the extraction agent.

However, due to the desired low process temperatures, the use of water vapor should be avoided wherever possible. However, stripping can be carried out with nitrogen without increasing the temperature.

However, if water vapor is to be used, it must be ensured that stripping takes place at approx. 60° C. and that the process pressure is low enough to prevent the water from condensing. This means that the process pressure must be below 0.2 bar a at 60° C.

The use of ambient air must be ruled out, as otherwise an explosive atmosphere may occur. atmosphere could arise.

The sequence of stripping and vacuum treatment can be varied and it is conceivable to dispense with one of the two processes if the desired limit value of extraction agent in the cake can be realized with only one process.

In embodiments of the invention, the trub oil is post-treated by passing it through an oil dryer.

The trub oil can be passed through an oil dryer if the remaining pressing aid should not escape into the surrounding atmosphere.

At a pressure of 70 mbar a, which can be realized relatively easily with a water ring pump, the oil degasses to an extractant content of approx. 5300 ppm (isopentane).

For the desired limit value of max. 300 ppm isopentane in the oil, a calculated pressure of approx. 3.5 mbar a is required. This pressure can be achieved with dry vacuum pumps, for example.

In particular in applications in rendering, in corresponding embodiments of the process according to the invention, the trub fat is separated from the solids it contains after leaving the strainer basket using a separating device. For example, the solids are separated from the tub fat using a (vibrating) sieve or using a sedimentation device.

At a pressure of 70 mbar a, which can be realized relatively easily with a water ring pump, the liquid grease degasses to an isopentane content of approx. 900 ppm.

For a desired limit value of max. 300 ppm extraction agent in the grease, a calculated pressure of approx. 20 mbar is required for isopentane. This pressure can be achieved with a mixing condenser, for example.

A fat temperature of 140° C. is assumed for the residues of the extraction agent in the liquid fat, which can be adjusted by a heat exchanger before injection into the pressurized atmosphere if necessary.

If the limit value for the extraction agent cannot be fully realized by remaining under negative pressure, it can be achieved using a stripping process. This usually involves passing superheated steam through the oil. As the oil has to be heated to high temperatures during subsequent refining anyway and the issue of the PDI value is irrelevant for the oil, this can be done without hesitation. Nevertheless, if gentle temperatures are important during oil processing, the oil can be treated using a stripping process with nitrogen or water vapor at a correspondingly low process pressure—see treatment of the press cake.

In a pressing method according to the invention, a pressing device according to the invention is preferably used.

The method according to the invention is particularly suitable for processing already digested oil-containing pressed material, as the extraction agent comes into such good contact with the oil to be extracted. Accordingly, post-pressing in general and final pressing with flaked seed are suitable for the application of the process according to the invention.

Exemplary embodiments of the invention are shown in the figures explained below. They show

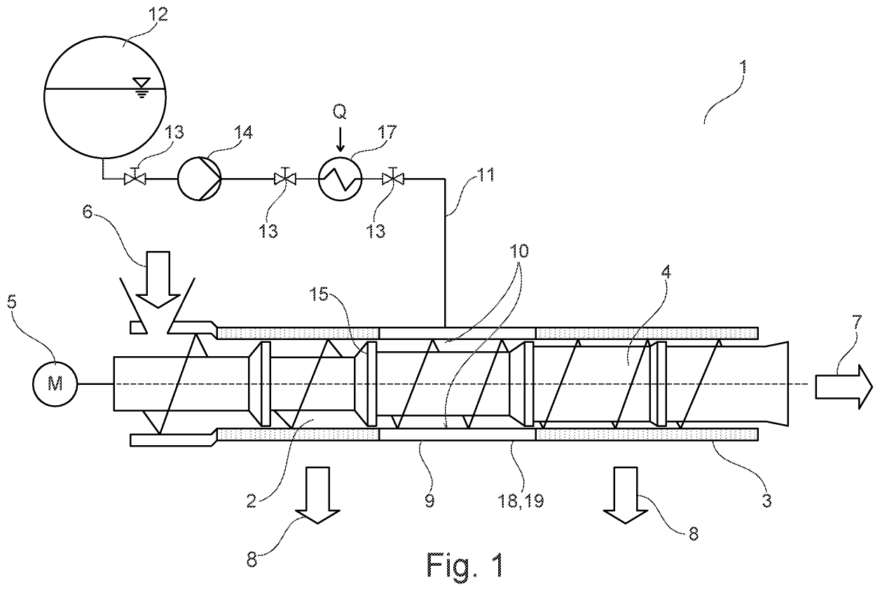

FIG. 1: A schematic representation of a longitudinal section through an embodiment of a pressing device according to the invention,

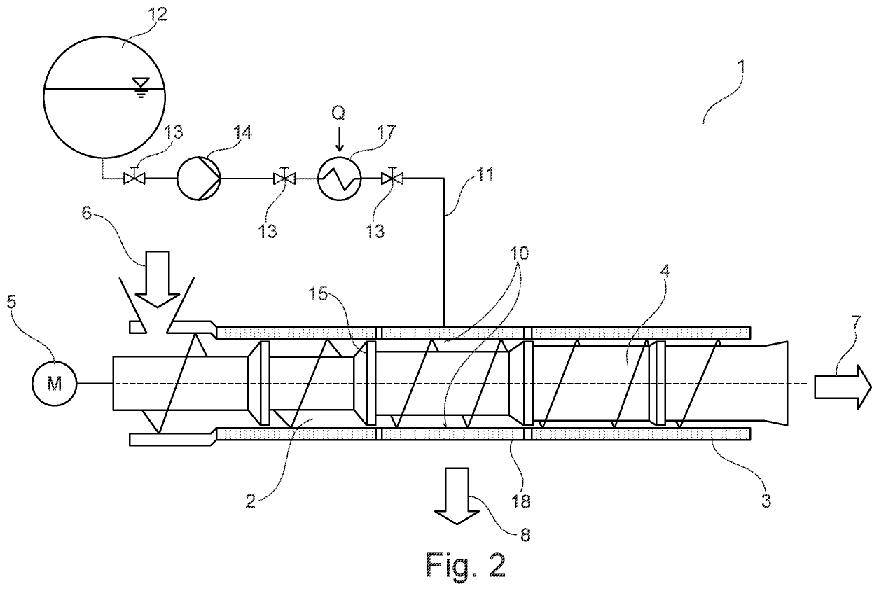

FIG. 2: A schematic representation of a longitudinal section through an alternative embodiment of a pressing device according to the invention,

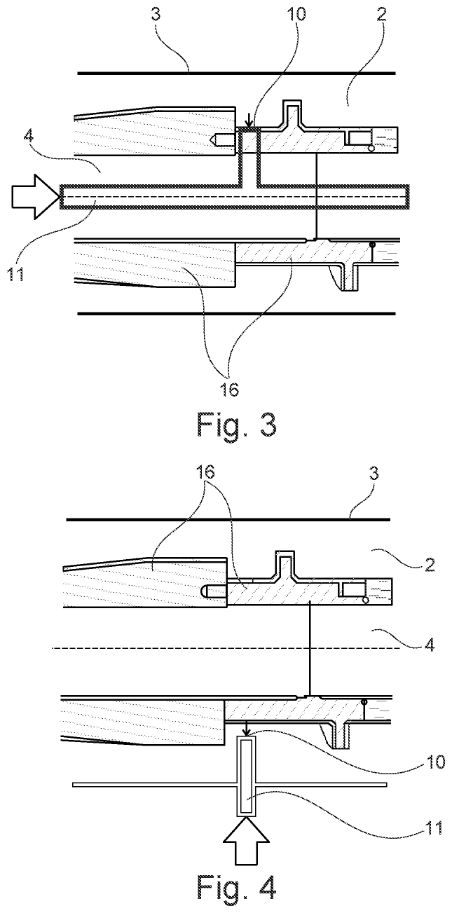

FIG. 3: A sectional schematic representation of a cross-section of an embodiment of a device for pressing in the area of the injection of the extraction agent according to the invention,

FIG. 4: A sectional schematic representation of a cross-section of an alternative embodiment of a device for pressing in the area of the injection of the extraction agent according to the invention,

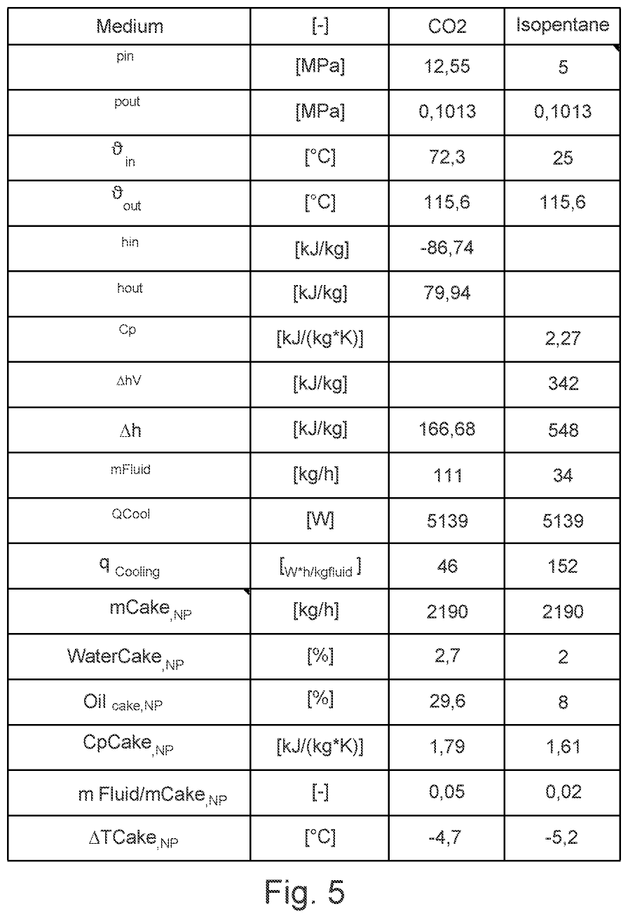

FIG. 5: A table with comparative values for parameters of the method according to the invention and

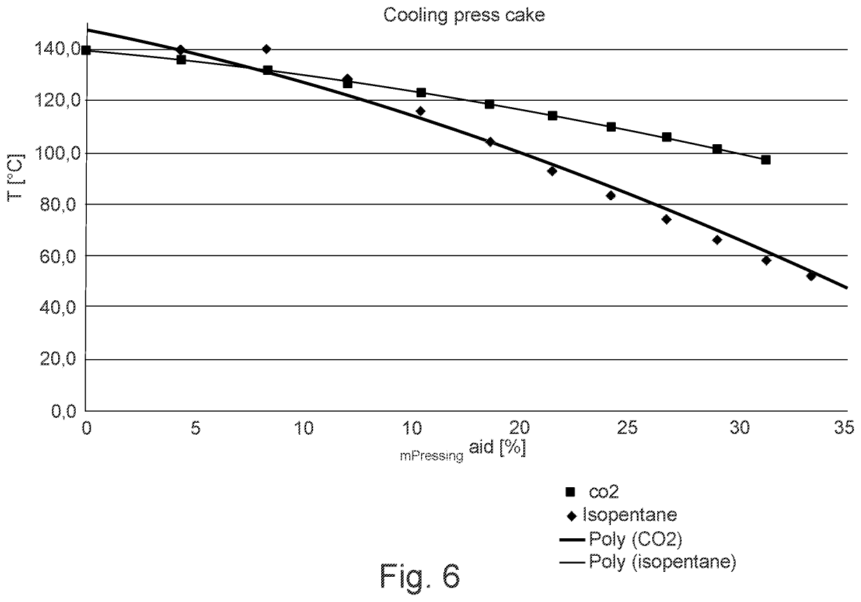

FIG. 6: A graphical representation of the cooling effect of isopentane compared to CO2.

FIG. 1 shows a schematic longitudinal section through a pressing device (1) according to the invention.

The embodiment shown of a device for pressing (1) according to the invention is designed as a screw press and has a pressing chamber (2) which extends in a tubular manner in the longitudinal direction of the device for pressing (1). The pressing chamber (2) is bounded in the radial direction by a strainer basket (3), which has a plurality of openings through which a pressed liquid (8) can emerge from the strainer basket (3).

A worm shaft (4) is rotatably mounted in the pressing chamber (2) and can be driven by means of a press drive (5). At a first end, the pressing device (1) has a feed opening (6) for the pressed material/pressed cake, which can then be conveyed through the pressing chamber (2) by means of the worm shaft (4). In the longitudinal direction of the pressing device (1), the screw flight formed between the worm shaft (4) and the strainer basket (3) becomes increasingly narrower, so that a continuously high pressure is exerted on the pressed material/pressed cake. At the second end of the pressing device (1), it has an outlet (7) for the pressed cake.

The pressing device (1) also has a strainer basket section in the form of an extraction ring (9). In the region of the extraction ring (9), the pressing device (1) has a plurality of extracting agent outlets (10), via which an extracting agent can be introduced into the pressing chamber (2) of the pressing device (1). The extracting agent outlets (10) are connected to an extracting agent source (12) via an extracting agent line (11).

Furthermore, the device for pressing (1) has an extraction agent valve (13), via which the supply of extraction agent into the pressing chamber (2) can be regulated or at least switched on and off in relation to the quantity supplied per unit of time (e.g. volume flow).

In addition, the illustrated embodiment of a device for pressing (1) has an extraction agent pump (14) with which the extraction agent can be conveyed from the extraction agent source (12) to the extraction agent outlets (10). Depending on the embodiment of the extraction agent source (12) and/or the extraction agent valve (13), variants without such an extraction agent pump (14) are also embodiments of a device for pressing (1) according to the invention. For example, the amount of extraction agent fed into the pressing chamber (2) can be adjusted with the aid of an extraction agent pump (14). In other embodiments, this can be adjusted via the pressure of the extraction agent source (12) and/or a corresponding control of the extraction agent valve (13), which is designed as a proportional valve, for example.

Furthermore, the device for pressing in the extraction agent feed system has a heat exchanger (17), via which the feed temperature of the extraction agent into the strainer basket (3) can be adjusted.

In the illustrated embodiment of the invention, the extraction ring (9) is arranged downstream of a throttle ring (15) in the conveying direction of the screw press, so that the extraction agent supply takes place in a relaxation zone.

FIG. 2 shows a schematic longitudinal section through an alternative pressing device (1) according to the invention.

The sealed area (18) is realized here by sealed openings in the strainer field in the area of the extraction agent outlets (10).

FIG. 3 shows a detailed view of an embodiment of a device for pressing (1) according to the invention in the region of an extracting agent outlet (10), wherein the extracting agent line (11) runs at least in some regions in the worm shaft (4) and the extracting agent outlet (10) is arranged on the worm shaft (4). Screw parts (16) are arranged on the worm shaft (4), which form various pressure zones, relaxation zones and conveying zones.

FIG. 4 shows an alternative embodiment of an extracting agent outlet (10) of a device for pressing (1) according to the invention, wherein the extracting agent outlet (10) extends from the outside through the strainer basket (3) into the pressing chamber (2). The opening of the extracting agent outlet (10) is arranged close to the screw.

For the purposes of this document, close to the screw means in close proximity to the outer surface of the worm shaft (4) or screw parts (16) arranged on the worm shaft. The illustration in FIG. 4 is not true to scale for all dimensions of devices for pressing (1) according to the invention with regard to the distance between the worm shaft (4) and the extraction agent outlet (10).

In embodiments of the invention, an arrangement of an extraction agent outlet (10) close to the screw means that it is designed to discharge the extraction agent at a distance of less than 1 cm, in particularly preferred embodiments at a distance of about 1 mm to 5 mm, from the outer surface of the worm shaft (4) or screw parts arranged on the worm shaft.

FIG. 5 shows a table showing the cooling effect of the addition of isopentane as an extraction agent with two different amounts of added extraction agent in comparison with supercritical CO2. In particular, due to the significantly higher enthalpy of vaporization of isopentane and also the significantly lower inlet temperature of 25° C. for isopentane compared to the inlet temperature of 72.3° C. for supercritical CO2, even lower mass flows of the pressing aids or extraction agents result in greater cooling of the press cake when isopentane is used, as the enthalpy difference of the pressing aid is more than three times greater. In this example, CO2 achieves a temperature difference of 4.7° C. in the cooled press cake, while 5.2° C. can be achieved with isopentane. With regard to the cooling effect of isopentane, these are theoretical values.

Assuming a press cake outlet temperature of approx. 140° C. after repressing, which is usual for two-stage finishing presses, a calculated temperature curve results as a function of the quantities of CO2 or isopentane added, as shown in FIG. 6 (calculated values at the markers, polynomials for interpolating the curve). According to the diagram, a press cake temperature of 60° C. results in a mass fraction of about 30% isopentane.

The calculation is based on the assumption that the press cake is always impregnated with an additional 10% extraction agent in relation to the other cake mass flow when it leaves the press and is otherwise completely vaporized. It is assumed that the CO2 evaporates completely within the press frame.

However, the actual cooling of the press cake can be assumed to be lower, as the evaporation of the extraction agent occurs when it leaves the strainer basket and not inside.

A press cake temperature of less than 60° C. is generally not desirable, as the extraction of the oil from the press cake is lower at lower temperatures.

The main advantage in the product quality of the press cake that can be achieved according to the invention is the higher PDI value, which indicates the percentage water solubility in relation to the total amount of protein in the product.

Due to the lower temperature, fewer phosphatides are transferred to the pressed oil, so that the degumming of the oil is less time-consuming or can be completely omitted when mixing the now higher quality post-pressing oil with pre-pressing oil.

When pressing mustard seeds, the allyl thiocyanate content is crucial for the product quality. For high-quality products, a value of 0.3 meq is aimed for, whereby a value of up to 0.26 meq is still considered acceptable. The content of allyl thiocyanate decreases with higher temperatures, so that the target value of 0.3 meq can be expected in the range of an oil temperature of around 70° C. In contrast, the usual oil temperature of conventional re-presses is approx. 100° C., so that a reduction in temperature according to the invention is accompanied by a significant improvement in oil quality.

Furthermore, existing conventional presses can be converted much more easily for use according to the teaching of the invention compared to the use of supercritical CO2 as a coolant, since only a few design adjustments to the presses are absolutely necessary.

Classic shaft cooling, in which a coolant is simply passed through the worm shaft, does not come close to achieving the required temperature reductions.

Compared to conventional solvent extraction with hexane, there are only negligible amounts of extraction agent in both the pressed oil and the press cake, which can also be easily removed, meaning that thermal post-treatment, which would have a negative impact on product quality, is no longer necessary.

In contrast to the use of nitrogen and CO2 as pressing aids, isopentane, for example, can be condensed with cooling water and recirculated into the process. This means that there is a considerable cost advantage due to the reusability of the pressing aid.

If the process parameters of the method according to the invention are selected in such a way that the residual fat content in the press cake can be significantly reduced, it may even be possible to dispense with the use of an extractor, which is expensive to purchase and operate, with subsequent treatment of the oil and press cake, and at the same time realize an acceptable residual fat content.

Alternatively, a smaller extractor can be considered due to the lower residual fat values after pressing.

1-23. (canceled)

24. A device for pressing configured as a screw press, comprising: a worm shaft; a pressing chamber in which a pressed material or pressed cake is pressable by the worm shaft; a strainer basket that bounds the pressing chamber in a radial direction; and means for supplying an extraction agent into the pressing chamber, the extraction agent being a fat dissolver.

25. The device for pressing according to claim 24, wherein the means for supplying the extraction agent are configured to supply the extraction agent in a liquid state.

26. The device for pressing according to claim 24, wherein the means for supplying an extracting agent includes an extracting agent source and at least one extracting agent outlet arranged so as to introduce the extracting agent into the pressing chamber.

27. The device for pressing according to claim 26, wherein the means for supplying an extracting agent further includes an extracting agent line that connects the extracting agent source to the at least one extracting agent outlet, and at least one of an extracting agent valve, an extracting agent pump and a heat exchanger that is arranged in a region of the extracting agent line.

28. The device for pressing according to claim 26, wherein the at least one extraction agent outlet is configured and arranged so that the extraction agent is introduced into the pressing chamber close to the worm shaft.

29. The device for pressing according to claim 26, further comprising a sealed region arranged at least in a region immediately adjacent to the extraction agent outlet in a conveying direction.

30. The device for pressing according to claim 29, wherein the sealed region is formed by a tube that delimits the pressing chamber in the radial direction.

31. The device for pressing according to claim 29, wherein the sealed region is formed so that openings between strainer bars in the sealed region are at least partially sealed.

32. The device for pressing according to claim 24, further comprising a recovery device for the extraction agent.

33. The device for pressing according to claim 24, further comprising a housing or casing that encapsulates the device for pressing in a gas-tight manner.

34. The device for pressing according to claim 24, further comprising an aspiration device.

35. The device for pressing according to claim 24, further comprising an inert gas supply.

36. The device for pressing according to claim 24, further comprising a trub shearing device.

37. The device for pressing according to claim 24, further comprising water-cooled drives.

38. The device for pressing according to claim 24, further comprising a breaker ring and/or a cake breaker for opening the pressed cake before the pressed cake leaves the device.

39. A method for pressing, comprising the steps of: introducing a pressed material or a pressed cake through a feed opening into a screw press; transporting and pressing the pressed material or the pressed cake with a warm shaft through a pressing chamber so that a liquid is pressed out of the pressed material or the pressed cake, and the pressed liquid emerges from the pressing chamber through openings; providing an extraction agent from an extraction agent source, wherein the extraction agent is a fat solvent; supplying the extraction agent from the extraction agent source into the press chamber in a liquid state; and cooling the press cake and/or the pressed liquid with aid of the extraction agent and dissolving oil contained in the press cake, wherein the extraction agent with the dissolved oil emerges from the pressing chamber through openings and evaporates.

40. The method for pressing according to claim 39, wherein the extraction agent is at least partially non-polar.

41. The method for pressing according to claim 39, wherein the extraction agent has a vapor pressure of 1.1 to 7 bar a at a temperature of 60° C.

42. The method for pressing according to claim 39, wherein the extracting agent has an enthalpy of vaporization of 280 KJ/kg to 400 KJ/kg at atmospheric pressure.

43. The method for pressing according to claim 39, wherein the extracting agent has a condensation temperature of between about 10° C. and 40° C. at atmospheric pressure.

44. The method for pressing according to claim 39, wherein the extraction agent is at least one of n-butane and isopentane.

45. The method for pressing according to claim 39, including introducing the extraction agent into the pressing chamber at a temperature of less than 70° C.

46. The method for pressing according to claim 39, including using a device for pressing comprising: a worm shaft; a pressing chamber in which a pressed material or pressed cake is pressed by the worm shaft; a strainer basket that bounds the pressing chamber in a radial direction; and means for supplying the extraction agent into the pressing chamber.
